(19) United States
(12) Patent Application Publication
(10) Pub. No.: US 2007/0146692 A1
(43) Pub. Date: Jun. 28, 2007

(54) Fiber optic specular surface flaw detection

(75) Inventors: Kamran Zaman, Pittsford, NY (US); Dante Pietrantoni, Rochester, NY (US); Ken Gottschalk, West Henrietta, NY (US); Stanley Pietrzykowski, Brighton, NY (US)

Correspondence Address: PEPPER HAMILTON LLP, ONE MELLON CENTER, 50TH FLOOR, 500 GRANT STREET, PITTSBURGH, PA, 15219, US

(73) Assignee: Xerox Corporation

(21) Appl. No.: 11/318,306

(22) Filed: Dec. 23, 2005

(51) Int. Cl. G01N 21/88

(52) U.S. Cl. 356/237.2

(57) ABSTRACT

An apparatus and a method for detecting low frequency specular surface flaws on coated substrates is disclosed. A method for detecting low frequency specular surface flaws may comprise: impinging visible electromagnetic radiation or light from an electromagnetic radiation source via a plurality of optical fibers onto the coated substrate, reflecting the visible electromagnetic radiation off the coated substrate as a reflected image, and recording the reflected image with a photosensitive device to form a recorded image.

### BACKGROUND

1. Technical Field

The disclosed embodiments generally relate to systems and methods for detecting flaws in coated articles.

2. Description of the Related Art

In the process of electrophotographic imaging, a photoconductive member is electrically charged to a uniform potential. The charged member is exposed to a light image of the original document. The light selectively discharges areas on the surface, while leaving other areas uncharged, thus producing an electrostatic latent image. A developer material, typically containing charged toner particles with opposite polarity as that of the photoconductive member is brought into contact with the exposed photoconductive member. The charged toner particles are transferred to oppositely charged areas on the photoconductive member's surface to form a visible image. An electrostatically charged blank copy sheet is brought into contact with the photoconductive member containing the toner particles, and the toner particles are transferred to the copy sheet. The toner particle image on the blank copy sheet is then heated to permanently affix the toner particles to the sheet to form a “hard copy” image.

Electrophotographic imaging members are well known in the art. An electrophotographic drum is typically used in copiers and printers, and comprises an electrically conductive hollow cylindrical metal substrate in the form of a tube. Typically, the tubes are made from aluminum or other reflective material. To achieve the desired dimensional properties required for these devices, the aluminum tubes are often machined on a lathe and left with a specular or mirror surface, which produces congruent reflection upon exposure to radiation.

The electrophotographic drums of this nature are coated, typically with several layers of coating material, with at least one of which coating layers comprising an organic photoconductive coating. These “layered photoreceptors” have at least a partially transparent photosensitive or photoconductive (“OPC”) layer overlying a conductive ground plane, which typically is comprised of the machined mirrored aluminum tube. The layers may be single-layered or multi-layered, such as members having an inner layer of undercoat material and an outer layer of change transport material. The tube may be rough or honed, and it may be made of other materials, such as other metals or conductive polymers.

Uniformity of the substrate surface and the coated substrate surface is critical for producing clear images in the electrophotographic process. Uniformity of the transparent or at least partially transparent coating (collectively referred to herein as “transparent coating”) is particularly critical for color electrophotographic imaging. Typically, the transparent coating mean thickness may be about 20 μm to about 30 μm. The transparent coating can have coating thickness defects ranging from about 1 μm to about 30 μm. Submicron-sized defects are also possible, while larger defects are possible with thicker coatings.

Coating thickness defects can be in the form of “dimples” which have a coating thickness lower than the mean coating thickness, or “bumps” which have a thickness greater than the mean coating thickness. The coating defects may appear as circumferential banding. When visible electromagnetic radiation, or light, is impinged upon these coating defects at an oblique angle, there is little or no light scattering; the reflection from these coating defects is primarily specular, that is there is a mirror angle reflection. These coating defects in general are referred to as low frequency specular surface flaws due to the subtle nature of the change in coating thickness that accompanies these defects and to the mirror angle specular reflectance of light from these defects.

Low frequency specular surface flaws can be categorized by their thickness difference with respect to the mean coating thickness. For example, in a coating having a thickness of about 25 μm, flaws on the order of about 1 μor less may be categorized as Level 0 (zero) flaws; flaws on the order of about 5 μm peak-to-peak (about 1.7 μm peak-to-reference) may be categorized as Level 1 (one) flaws; flaws on the order of about 7.5 μm peak-to-peak (about 5 μm peak-to-reference) may be categorized as Level 2 flaws, and flaws on the order of about 21 μm peak-to-peak (about 18 μm peak-to-reference) may be categorized as Level 3 flaws

Low frequency specular surface flaws detrimentally affect the performance of the OPC drum photoreceptor in reproducing images. Flaws as small as about 1 μm can have a detrimental effect on the reproduced image. As indicated, the flaws are areas of different coating thicknesses, and as such they have different charging and discharging properties as compared with the flawless areas of the coating and as compared with each other. This typically results in banding on the final image. This is even more critical in high speed color xerographic engines where color registration is critical for true color image reproduction.

Currently, machine vision inspection methods for detecting surface flaws, in general, include dark field angle, use of broad structured light, and laser profiling, for example as taught in U.S. Pat. No. 6,157,450, the disclosure of which is incorporated herein by reference in its entirety. These methods, however, have proved not to be useful in detecting low frequency specular surface flaws on coated substrates. Low frequency specular surface flaws of Level 3 or lower can only currently be observed by manual visual inspection. This method is tedious, inefficient, costly, and time consuming. A cost efficient, automated surface flaw detection means is needed.

Accordingly, there is a need for an improved apparatus and method for detecting low frequency specular surface flaws on coated substrates.

### SUMMARY

The disclosure is directed to an apparatus and a method for detecting low frequency specular surface flaws on coated substrates. In one embodiment, a method for detecting low frequency specular surface flaws may comprise: providing a light source, transmitting the light from the light source into a fiber optic light line. The fiber optic light line comprises a plurality of optical fibers. The plurality of optical fibers have a corresponding plurality of fiber optic tips at the end of the plurality of optical fibers. The plurality of fiber optic tips may be arranged at the emitting end of the fiber optic light line either randomly or in a defined pattern. Each individual fiber optic tip in the plurality of fiber optic tips functions as an individual light source. The plurality of fiber optic tips are placed in proximity of the coated substrate such that they emit light onto the coated substrate. No focusing lens is used in between the plurality of fiber optic tips and the coated substrate. As such, the emitted light lacks integration, resulting in the light from individual fiber optic tips to be incident on the coated surface at various angles. This results in reflection of the light to occur at various angles. Since the light is reflected from the surface at various angles, the contrast of the coating is enhanced, enabling flaw detection of a coated substrate specular surface. The light is reflected off of the coated substrate to form a surface flaw reflected image. The surface flaw reflected image is recorded directly from the coated surface using a photosensitive device.

In another embodiment, the substrate may be rotated using a motor along a rotational axis, such as a longitudinal axis. Rotation of the substrate allows recording a reflected image of the circumferential dimension of the coated substrate.

In a further embodiment, the photosensitive device used to record the reflected image from the coated substrate comprises a camera. The camera may be one that records the image on film or it may be of the digital imaging type. It is recognized that any suitably sensitive camera, regardless of how the camera stores or records the image, could be used to record the reflected image from the coated substrate. In one embodiment, the camera used to record the reflected image off the coated substrate comprises an area scan charge-coupled device (CCD). In a further embodiment, the area scan charge-coupled device has a pixel size of about 14 μm by about 14 μm. In still another embodiment, the camera comprises a line scan camera. In another embodiment, the camera comprises an area scan complementary metal-oxide-semiconductor (CMOS) device.

In still another embodiment the recorded reflected image is digitally processed to determine a dimensional characterization of the specular surface flaws. Factors such as intensity and size of the recorded reflected surface flaws are processed using digital image processing to determine dimensional characteristics such as, but not limited to, flaw heights or depths, and flaw widths and lengths. Digital image processing algorithms are known in the art and any such algorithm know in the art can be adapted in this embodiment.

Yet another embodiment comprises a method for detecting specular surface flaws on a coated organic photoconductor (OPC) drum. This method may comprise providing a light source, transmitting the light from the light source into a fiber optic light line. The fiber optic light line comprises a plurality of optical fibers. The plurality of optical fibers comprise a corresponding plurality of fiber optic tips at the end of the plurality of optical fibers. The plurality of fiber optic tips may be arranged at the emitting end of the fiber optic light line either randomly or in a defined pattern. Each individual fiber optic tip in the plurality of fiber optic tips functions as an individual light source or point source. The plurality of fiber optic tips are placed in proximity of the OPC drum such that they emit light onto the OPC drum. No focusing lens is used in between the plurality of fiber optic tips and the OPC drum. As such, the emitted light lacks integration, resulting in the light from individual fiber optic tips to be incident on the OPC drum at various angles. This results in reflection of the light to occur at various angels. Since the light is reflected from the surface at various angles, the contrast of the coating on the OPC drum is enhanced, enabling flaw detection of a coated OPC drum specular surface. The light is reflected off of the OPC drum to form a surface flaw reflected image. The surface flaw reflected image is recorded directly from the OPC drum using a photosensitive device. This method may include rotating the coated organic photoconductor drum along its drum axis, while impinging light from a plurality of fiber optic tips onto the OPC drum. In a further embodiment, the recorded reflected image is subjected to digital image processing to determine flaw dimensional characteristics.

Still yet another embodiment is an apparatus for detecting specular surface flaws on a coated substrate. The apparatus comprises a visible a light source, and a fiber optic line for transmitting the light from the light source. The fiber optic light line comprises a plurality of optical fibers, or a bundle of fibers. The plurality of optical fibers comprise a corresponding plurality of fiber optic tips at the end of the plurality of optical fibers. The plurality of fiber optic tips may be arranged at the emitting end of the fiber optic light line either randomly or in a defined pattern. Each individual fiber optic tip in the plurality of fiber optic tips functions as an individual light source. The plurality of fiber optic tips are placed in proximity of a coated substrate such that they emit light onto the coated substrate. No focusing lens is used in between the plurality of fiber optic tips and the coated substrate. The light that reflects off of the coated substrate forms a surface flaw reflected image. The apparatus further comprises a photosensitive device positioned above the coated substrate in order to directly record the surface flaw reflected image. In a further embodiment, the recorded reflected image is subjected to digital image processing to determine flaw dimensional characteristics.

In yet another embodiment, the apparatus comprises a rotation means for rotating the substrate along a rotational axis, such as a longitudinal axis.

The photosensitive device of the apparatus may comprise a camera. One embodiment of the apparatus comprises an area scan charge-coupled device (CCD). In still another embodiment, the camera comprises a line scan camera. In another embodiment, the camera comprises an area scan complementary metal-oxide-semiconductor (CMOS) device. The camera of the apparatus may comprise any suitably sensitive film-type or digital imaging camera.

### BRIEF DESCRIPTION OF THE DRAWINGS

FIG. 1A illustrates exemplary fiber optic apparatus and method for detecting low frequency specular surface flaws.

FIG. 1B is a blow up drawing of an emitting end of a fiber optic light line depicting an exemplary arrangement of a plurality of fiber optic tips.

FIG. 1C is an exaggerated in scale depiction of part an embodiment of a method depicting detection of a low frequency specular surface flaw.

FIG. 2 is a reflected specular surface flaw image recorded from organic photoconductor drum as practiced in one embodiment.

FIG. 3 illustrates an exemplary image processing method.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention.

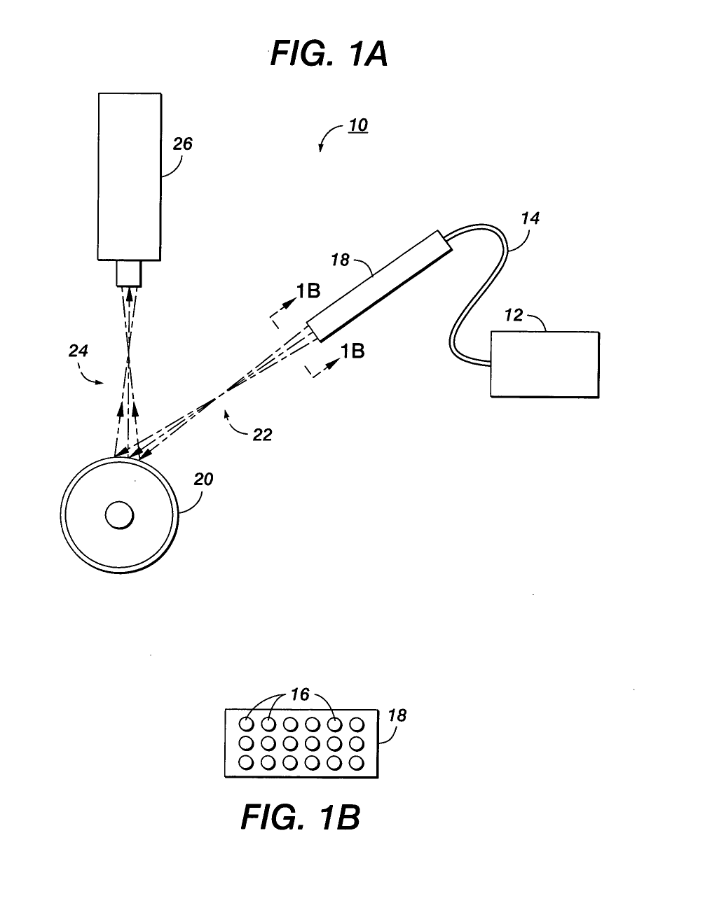

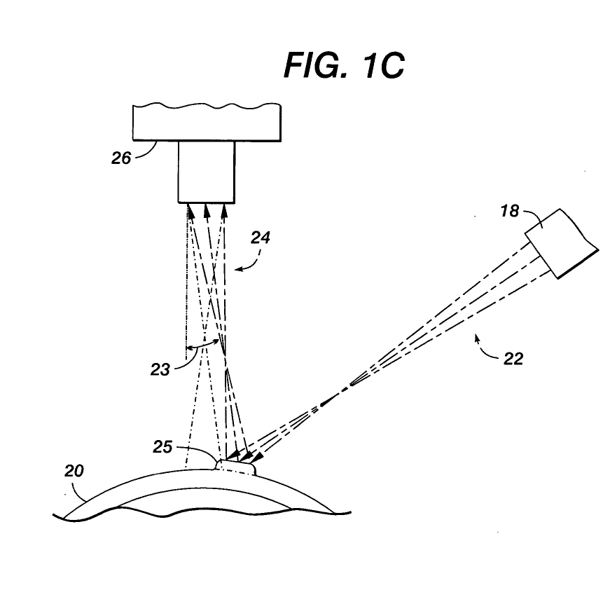

In accordance with one embodiment, as illustrated in FIG. 1A, an apparatus 10 to detect low frequency specular surface flaws is depicted. The apparatus 10 comprises a visible light source 12 and a fiber optic light 14 line for transmitting the light from the light source. In one embodiment, the light source of the apparatus may emit monochromatic light, that is, visible electromagnetic radiation comprising one wavelength. In another embodiment, the light source of the apparatus may emit multispectral light, that is, visible electromagnetic radiation comprising more than one wavelength. The fiber optic light line comprises a plurality of optical fibers encased in an outer material or otherwise bound. In one embodiment, for example, the diameter of each optical fiber is about 100 μm. Any suitable fiber optic materials may be used for these embodiments: for example, including but not limited to Fostec Light Line part # A08912 D (SCHOTT North America, Inc.). Persons having ordinary skill in the art will recognize that other standard fiber optic fibers, optic fiber bundles, and optic fiber materials can be used in the embodiments described herein.

The plurality of optical fibers comprise a corresponding plurality of fiber optic tips 16 at the emitting end 18 (see FIG. 1B) of the fiber optic light line 14. In one embodiment the plurality of fiber optic tips 16 is placed at about 5 mm to about 200 mm from the coated substrate 20. This distance is referred to herein as the standoff or standoff distance. In another embodiment, the standoff is about 10 mm to about 100 mm. In yet another embodiment the standoff is about 60 mm. The intensity of the point source of light that is emitted from the plurality of fiber optic tips 16 diminishes with increasing standoff distance. The plurality of fiber optic tips 16 may be arranged at the emitting end 18 of the fiber optic light line 14 either randomly or in a defined pattern.

FIG. 1B is a blow up drawing of an emitting end of a fiber optic light line 18 illustrating an exemplary arrangement of a plurality of fiber optic tips 16. In this exemplary embodiment, the plurality of fiber optic tips 16 are arranged in a definite rectangular “3×6” pattern. It is recognized that other patterns, such as for example, square patterns, and random patterns for the plurality of fiber optic tips 16 could be used. It is also recognized that the actual number of fiber optic tips that comprise the plurality of fiber optic tips 16 can be any number greater than one (1), with the upper limit depending upon the area to be scanned and the desired contrast of the recorded specular surface flaw image. Increasing the number of fiber optic tips serves to increase contrast of the recorded specular surface flaw image. Each individual fiber optic tip in the plurality of fiber optic tips 16 functions as an individual light source or point source of light. The plurality of fiber optic tips 16 are placed in proximity of a coated substrate 20 such that they emit light 22 incident at various angles onto the coated substrate 20. As such, each point source of light emitted from the plurality of fiber optic tips 16 is incident on the coated substrate 20 at different angles 23 (see FIG. 1C). Light reflects at various angles 24 off of the coated substrate 20 and forms a surface flaw reflected image. The apparatus further comprises a photosensitive device 26 positioned above the coated substrate 20 in order to directly record the surface flaw reflected image. In a further embodiment, the recorded reflected image is subjected to digital image processing to determine flaw dimensional characteristics.

A suitably sensitive photosensitive device 26 is provided to record the surface flaw reflected image off of the coated substrate 20. The photosensitive device 26 may comprise a camera. The camera may be of the film-type, which typically use emulsion photographic films to capture images, or of the digital type. An embodiment of a camera comprises a charge-coupled device (CCD) area scan camera. In yet another embodiment, the camera comprises a line scan camera. Another embodiment for the suitably sensitive photosensitive device 26 comprises an area scan complementary metal-oxide-semiconductor (CMOS) device.

Optionally the apparatus further comprises a coated substrate rotating means (not shown). The rotating means may comprise, for example, an electric motor (not shown) integrally attached to a coated substrate suspending member (not shown). The coated substrate 20 may be affixed to the coated substrate suspending member and rotated during illumination to reflect light toward the photosensitive device 26 and provide a recorded specular surface flaw reflected image in the photosensitive device 26. It is recognized that a rotating means other than an electric motor, for example but not limited to, a battery operated motor, are effective for the apparatus 10 to detect low frequency specular surface flaws. The rotating means of the apparatus should provide coated substrate rotation speeds of about 1 revolution per minute (rpm) to about 100 rpm. In another embodiment, rotation speeds may be about 40 rpm to about 60 rpm. In another embodiment, rotation speeds may be about 50 rpm It should be recognized that faster rotation speeds of the coated substrate may expedite the flaw detection, and that the rotation speed is currently only limited by the camera frame rate and the number of pixels available for digital image processing. However, it should also be recognized that rotation is not required to practice the embodiments described herein, and the methods described may be used on coated cylindrical objects, coated flat objects, or other surfaces.

A further embodiment of the invention is a method for detecting low frequency specular surface flaws on coated substrates. Referring again to FIGS. 1A and 1B, an embodiment of this method may comprise providing a light source 12, transmitting the light 22 from the light source 12 into a fiber optic light line 14. The fiber optic light line 14 comprises a plurality of optical fibers (not shown) encased in an outer material, or otherwise bound. The plurality of optical fibers comprise a corresponding plurality of fiber optic tips 16 at the end of the plurality of optical fibers. The plurality of fiber optic tips 16 may be arranged at the emitting end of the fiber optic light line 18 either randomly or in a defined pattern.

FIG. 1C is an exaggerated in scale depiction of part an embodiment of a method depicting detection of a low frequency specular surface flaw 25. Now referring to FIGS. 1A, 1B, and 1C, each individual fiber optic tip 16 in the bundle 18 of fiber optic tips functions as an individual light source or point source of light. The plurality of fiber optic tips are placed in proximity of the coated substrate 20 such that they emit light onto the coated substrate 20. No focusing lens is used in between the plurality of fiber optic tips and the coated substrate 20. As such, the emitted light 22 lacks integration, resulting in the light from individual fiber optic tips to be incident on the coated substrate 20 at various angles 23. This results in reflected light at various angles 24. Since the light is reflected at various angles 24 from the coated substrate 20, the contrast of the image of the coating on the coated substrate 20 is enhanced, enabling flaw detection of a coated substrate 20. The reflected light at various angles 24 off of the coated substrate 20 forms a surface flaw reflected image. The surface flaw reflected image is recorded directly from the coated substrate using a photosensitive device 26. This method may optionally include rotating the coated substrate 20, utilizing a rotating means (not shown), while impinging light 22 from a plurality of fiber optic tips 16 onto the coated substrate 20. In a further embodiment, the recorded reflected image is subjected to digital image processing to determine flaw dimensional characteristics. The image captured by the photosensitive device 26 may be digitally processed using a computer (not shown) and digital imaging processing software, which are known to persons having ordinary skill in the art and can be adapted for the purpose of embodiments herein.

A further embodiment may comprise an organic photoconductor drum as the coated substrate 20.

In yet another embodiment the suitably sensitive photosensitive device 26 used to record the surface flaw reflected image off of the coated substrate 20 may comprise a camera. The camera may be of the film-type, which typically use emulsion photographic films to capture images, or of the digital type. An embodiment of a camera comprise a charge-coupled device (CCD) area scan camera. Another embodiment of a camera comprises a line scan camera. Yet another embodiment for the suitably sensitive photosensitive device 26 comprises an area scan complementary metal-oxide-semiconductor (CMOS) device.

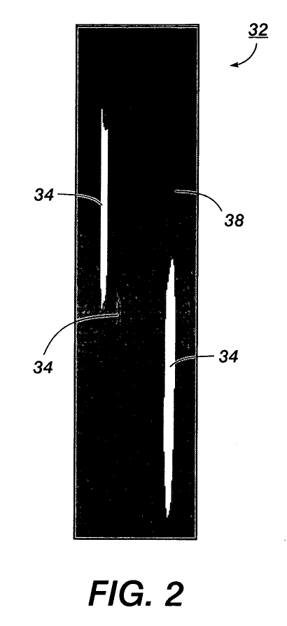

Now referring to FIG. 2, a black and white reproduction of a specular surface flaw reflected image 32 from a coated substrate 14 comprising an OPC drum is presented. The surface flaws 34 in the specular surface flaw reflected image 32 appear as areas of varying contrast. The flaws 34 appear in the image due to differences in interference of the reflected electromagnetic radiation 30 from flawed 34 and flawless 38 areas. This is a result of the lack of integration of the light that is emitted from each point source, that is from individual optic fibers, in the plurality of fiber optic tips. In various experiments, flaws having a peak-to-peak size as small as 21 μm were detected using embodiments described herein.

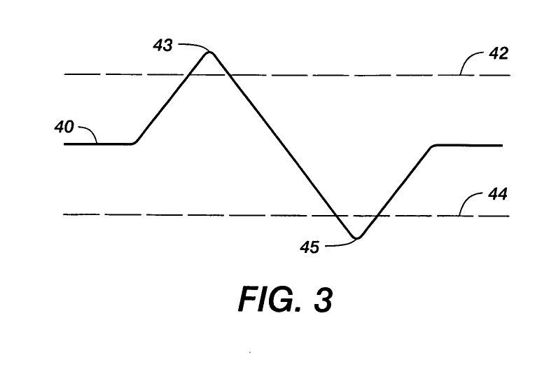

Using a suitably sensitive photosensitive device 26 to record the specular surface flaw reflected image off of a coated substrate may provide detection of flaws down to the size of Level 3, or about 21 μm peak-to-reference, or less. This flaw detection level was obtained, for example, when the photosensitive device 26 comprised an area scan charge-coupled device camera. Flaw detection may then be used with any suitable image processing technique to detect variations in the captured image. For example, referring to FIG. 3, a portion of the reflected image may be processed on a pixel-by-pixel basis, and flaws may be indicated by measuring an intensity level 40 for each pixel. If a pixel intensity level exceeds an upper threshold 42 it may indicate a defect 43. Similarly, if a pixel intensity level is lower than a lower threshold 44, it may indicate a defect 45.

It will also be recognized that the embodiments described herein may be used on various substrates with transparent coatings. For example, an OPC drum may be coated with any suitable coating or coatings to fabricate a photosensitive imaging member. Such coatings may include multi-layer coatings, such as a barrier uncoat material (UCM) may be applied, along with a charge generating material (CGM) and a charge transport material (CTM). The CGM and CTM may be in different layers or in a single layer along with a binder resin. Typical organic photoconductive CGMs include, for example, one or more of azo pigments, such as Sudan Red, Dian Blue, Janus Green B, and the like; quinone pigments such as Algol Yellow, Pyrene Quinone, Indanthrene Brilliant Violet RRP, and the like; quinocyanine pigments; perylene pigments; indigo pigments such as indigo, thioindigo, and the like; bisbenzoimidazole pigments such as Indofast Orange toner, and the like; phthalocyanine pigments such as copper phthalocyanine, aluminochloro-phthalocyanine, titanyl phthalocyanine, hydroxy gallium phthalocyanine and the like; quinacridone pigments; or azulene compounds. Typical inorganic photoconductive CGMs include, for example, cadmium sulfide, cadmium sulfoselenide, cadmium selenide, crystalline and selenium, lead oxide and other chalcogenides.

Typical CTMs include, for example, one or more organic polymer or non-polymeric materials capable of supporting the injection of photoexcited holes or transporting electrons from the photoconductive material and allowing the transport of these holes or electrons through the organic layer to selectively dissipate a surface charge. Typical CTMs may also include, for example, a positive hole transporting material selected from compounds having in the main chain or the side chain a polycyclic aromatic ring such as anthracene, pyrene, phenanthrene, coronene, and the like, or a nitrogen-containing hetero ring such as indole, carbazole, oxazole, isoxazole, thiazole, imidazole, pyrazole, oxadiazole, pyrazoline, thiadiazole, triazole, hydrazone compounds, and the like. Other typical CTMs may include electron donor materials, such as carbazole; N-ethyl carbazole; N-isopropyl carbazole; N-phenyl carbazole; tetraphenylpyrene; 1-methyl pyrene; perylene; chrysene; anthracene; tetraphene; 2-phenyl naphthalene; azopyrene; 1-ethyl pyrene; acetyl pyrene; 2,3-benzochrysene; 2,4-benzopyrene; 1,4-bromopyrene; poly(N-vinylcarbazole); poly(vinylpyrene); poly(vinyltetraphene); poly(vinyltetracene), poly(vinylperylene), and the like. Typical electron transport materials include, for example, electron acceptors such as 2,4,7-trinitro-9-fluorenone; 2,4,5,7-tetranitro-fluorenone; dinitroanthracene; dinitroacridene; tetracyanopyrene, dinitroanthraquinone, and the like. The CTM may also incorporate an antioxidant such as butylated hydroxyl toluene to inhibit oxidation and deterioration of the CTM. The CTM may also incorporate poly(tetrafluoroethylene) (PTFE) in order to reduce wear and enable more efficient toner transfer.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of detecting a low frequency specular surface flaw on a coated substrate, comprising:
providing a light source;
transmitting light from the light source into a fiber optic line, the fiber optic light line comprising a plurality of optical fibers, wherein the plurality of optical fibers further comprises a corresponding plurality of fiber optic tips;
emitting the light from the plurality of fiber optic tips onto a coated substrate, without the use of an integrating lens between the plurality of fiber optic tips and the coated substrate; and
recording a reflected image off the coated substrate with a photosensitive device to form a recorded reflected image.

2. The method of claim 1 wherein the coating is at least partially transparent.

3. The method of claim 1 wherein the coated substrate comprises a cylindrical drum.

4. The method of claim 1 wherein the coated substrate is rotated about a rotational axis.

5. The method of claim 1 wherein the plurality of fiber optic tips are arranged randomly.

6. The method of claim 1 wherein the plurality of fiber optic tips are arranged in a definite pattern.

7. The method of claim 1 wherein the recorded reflected image is digitally processed to obtain dimensional characteristics of a low frequency specular surface flaw.

8. The method of claim 1 wherein the photosensitive device comprises a charge-coupled device area scan detector camera.

9. The method of claim 1 wherein a standoff distance between the coated substrate and the plurality of fiber optic tips is about 60 mm.

10. A method of detecting a low frequency specular surface flaw on a organic photoconductor drum, comprising:
providing a light source;
transmitting light from the light source into a fiber optic line, the fiber optic light line comprising a plurality of optical fibers, wherein the plurality of optical fibers further comprises a corresponding plurality of fiber optic tips;
emitting the light from the plurality of fiber optic tips onto a organic photoconductor drum, without the use of an integrating lens between the plurality of fiber optic tips and the organic photoconductor drum; and
recording a reflected image off the coated substrate with a photosensitive device to form a recorded reflected image.

11. The method of claim 10 wherein the recorded reflected image is digitally processed to obtain dimensional characteristics of a low frequency specular surface flaw.

12. The method of claim 10 wherein the photosensitive device comprises an area scan charge-coupled device camera.

13. An apparatus, comprising:
a visible light source;
a fiber optic light line for transmitting light from the light source, wherein the fiber optic light line further comprises a plurality of optical fibers, wherein the plurality of optical fibers further comprises a corresponding plurality of fiber optic tips that emit light directly at various angles onto a coated substrate;
a photosensitive device positioned to directly record a recorded reflected image from the coated substrate.

14. The apparatus of claim 13 further comprising a motor that rotates the coated substrate along a rotational axis of the substrate.

15. The apparatus of claim 13 further comprising a means for digitally processing the recorded reflected image to determine flaw dimensional characteristics.

16. The apparatus of claim 13 wherein the plurality of fiber optic tips are arranged in a random fashion.

17. The apparatus of claim 13 wherein the plurality of fiber optic tips are arranged in a definite pattern.

18. The apparatus of claim 13 wherein a standoff distance between the coated substrate and the plurality of fiber optic tips is about 60 mm.

19. The apparatus of claim 13 wherein the photosensitive device comprises a camera.

20. The apparatus of claim 19 wherein the camera comprises an area scan charge-coupled device camera.
